(19) United States
(12) Patent Application Publication
(10) Pub. No.: US 2022/0134622 A1
(43) Pub. Date: May 5, 2022

(54) Injection Molding Machine Management System And Injection Molding Machine Management Method

(71) Applicant: Seiko Epson Corporation, Tokyo (JP)

(72) Inventors: Ko TSUKADA, Shiojiri (JP); Yoshiaki OTSUKI, Matsumoto (JP); Yusuke MITSUMA, Shiojiri (JP)

(21) Appl. No.: 17/518,701

(22) Filed: Nov. 4, 2021

(30) Foreign Application Priority Data
Nov. 5, 2020 (JP) 2020-185185

(51) Int. Cl. B29C 45/76

(52) U.S. Cl. CPC B29C 45/76; B29C 2945/76939

(57) ABSTRACT

An injection molding machine management system includes an injection molding machine, a storage section that stores mold identification information and material identification information, an information input section that is configured to input molded product information, material information, and mold information, a determination section that determines whether or not a mold and a material to be used are an appropriate mold and an appropriate material in correspondence to a molded product to be molded; and a display section that performs display based on a determination result in the determination section, in which the determination section determines whether or not the mold and the material are appropriate in correspondence to the molded product to be molded by using the material information, the mold information, the mold identification information, and the material identification information based on the molded product information, and the display section displays a mold replacement time and a material replacement time required to replace the mold and the material when the determination section determines that the mold and the material are not appropriate in correspondence to the molded product to be molded.

The present application is based on, and claims priority from JP Application Serial Number 2020-185185, filed Nov. 5, 2020, the disclosure of which is hereby incorporated by reference herein in its entirety.

### BACKGROUND

### 1. Technical Field

The present disclosure relates to an injection molding machine management system and an injection molding machine management method.

### 2. Related Art

In the related art, various injection molding machines have been used in which a material is injected into a mold to form a molded product. For example, JP-A-2017-202628 discloses an injection molding machine capable of starting a molding operation when it is confirmed that mold identification information of an attached mold is mold identification information of a specific mold.

However, in the injection molding machine of JP-A-2017-202628, it is not considered to determine whether or not a material used is a predetermined material. Since molding conditions for an injection molding machine are determined based on mold identification information, when a material having a melting point higher than that of a predetermined material is erroneously charged, there is concern that the material may not be appropriately melted in an injection section of the injection molding machine and an excessive load may be generated on a screw. When a material having a melting point lower than that of a predetermined material is erroneously charged, the material is overheated and does not have an appropriate viscosity, and an injection pressure applied to a mold is reduced. Thus, a reaction force corresponding to the injection pressure with respect to a force for tightening the mold is reduced, and thus there is concern that the mold may be compressed more than necessary. The injection molding machine in JP-A-2017-202628 has a problem that it is difficult for an operator to recognize how much time load it takes to replace a mold. As described above, the injection molding machine of the related art cannot be said to be properly managed.

### SUMMARY

An injection molding machine management system according to an aspect of the present disclosure includes an injection molding machine that is configured to inject a material into a mold to mold a molded product; a storage section that stores mold identification information of an appropriate mold determined in correspondence to a molded product to be molded and material identification information of an appropriate material determined in correspondence to the molded product to be molded; an information input section that is configured to input molded product information of the molded product to be molded, material information of a material to be used, and mold information of a mold to be used; a determination section that determines whether or not the mold and the material to be used are the appropriate mold and the appropriate material in correspondence to the molded product to be molded; and a display section that performs display based on a determination result in the determination section, in which the determination section determines whether or not the mold and the material to be used are the appropriate mold and the appropriate material in correspondence to the molded product to be molded by using the material information and the mold information that are input from the information input section and the mold identification information and the material identification information stored in the storage section based on the molded product information that is input from the information input section, and the display section displays a mold replacement time required to replace the mold when the determination section determines that the mold is not appropriate in correspondence to the molded product to be molded, and displays a material replacement time required to replace the material when the determination section determines that the material is not appropriate in correspondence to the molded product to be molded.

An injection molding machine management method according to another aspect of the present disclosure is an injection molding machine management method in an injection molding machine configured to inject a material into a mold to mold a molded product, the injection molding machine management method including a storage step of stores, in a storage section, mold identification information of an appropriate mold determined in correspondence to a molded product to be molded and material identification information of an appropriate material determined in correspondence to the molded product to be molded; an information input step of inputting molded product information of the molded product to be molded, material information of a material to be used, and mold information of a mold to be used; a determination step of determining whether or not the mold and the material to be used are the appropriate mold and the appropriate material in correspondence to the molded product to be molded; and a display step of performing display based on a determination result in the determination step, in which in the determination step, it is determined whether or not the mold and the material to be used are the appropriate mold and the appropriate material in correspondence to the molded product to be molded by using the material information and the mold information that are input in the information input step and the mold identification information and the material identification information stored in the storage section based on the molded product information that is input in the information input step, and in the display step, a mold replacement time required to replace the mold is displayed when it is determined in the determination step that the mold is not appropriate in correspondence to the molded product to be molded, and a material replacement time required to replace the material is displayed when it is determined in the determination step that the material is not appropriate in correspondence to the molded product to be molded.

### BRIEF DESCRIPTION OF THE DRAWINGS

FIG. 1 is a diagram illustrating a schematic configuration of an injection molding machine management system according to an example of the present disclosure.

FIG. 2 is a flowchart illustrating an example of an injection molding machine management method performed by using the injection molding machine management system in FIG. 1.

FIG. 3 illustrates a display example on a display section when it is determined that a mold is not appropriate in the flowchart of FIG. 2.

FIG. 4 illustrates a display example on a display section different from that in FIG. 3.

FIG. 5 illustrates an example of display on a display section when it is determined that a material is not appropriate in the flowchart of FIG. 2.

### DESCRIPTION OF EXEMPLARY EMBODIMENTS

First, the present disclosure will be described schematically.

According to a first aspect of the present disclosure, there is provided an injection molding machine management system including an injection molding machine that is configured to inject a material into a mold to mold a molded product; a storage section that stores mold identification information of an appropriate mold determined in correspondence to a molded product to be molded and material identification information of an appropriate material determined in correspondence to the molded product to be molded; an information input section that is configured to input molded product information of the molded product to be molded, material information of a material to be used, and mold information of a mold to be used; a determination section that determines whether or not the mold and the material to be used are the appropriate mold and the appropriate material in correspondence to the molded product to be molded; and a display section that performs display based on a determination result in the determination section, in which the determination section determines whether or not the mold and the material to be used are the appropriate mold and the appropriate material in correspondence to the molded product to be molded by using the material information and the mold information that are input from the information input section and the mold identification information and the material identification information stored in the storage section based on the molded product information that is input from the information input section, and the display section displays a mold replacement time required to replace the mold when the determination section determines that the mold is not appropriate in correspondence to the molded product to be molded, and displays a material replacement time required to replace the material when the determination section determines that the material is not appropriate in correspondence to the molded product to be molded.

According to this aspect, it is determined whether or not the mold and the material to be used are the appropriate mold and the appropriate material in correspondence to the molded product to be molded by using the mold information and the material information that are input from the information input section and the mold identification information and the material identification information stored in the storage section. Thus, it is possible to determine whether or not only the mold to be used but also the material to be used is appropriate. The display section displays the mold replacement time or the material replacement time required to replace the mold or the material when the mold or the material is not appropriate in correspondence to the molded product to be molded. Thus, when the mold or material to be used is not appropriate, an operator can be informed of the time required to replace the mold or the material with an appropriate one. Therefore, according to this aspect, the injection molding machine can be appropriately managed.

A second aspect of the present disclosure provides the injection molding machine management system according to the first aspect, which may further include a plurality of the injection molding machines, in which the storage section may store injection molding machine identification information of an appropriate injection molding machine determined in correspondence to each of molded products to be molded, the information input section may be configured to input injection molding machine information of an injection molding machine to be used, the determination section may determine whether or not the injection molding machine to be used is the appropriate injection molding machine in correspondence to the molded product to be molded by using the injection molding machine identification information stored in the storage section based on the molded product information that is input from the information input section, and the display section may display an injection molding machine replacement time required to replace the injection molding machine when the determination section determines that the injection molding machine is not appropriate in correspondence to the molded product to be molded.

According to this aspect, it is determined whether or not the injection molding machine to be used is the appropriate injection molding machine in correspondence to the molded product to be molded by using the injection molding machine information that is input from the information input section and the injection molding machine identification information stored in the storage section. Therefore, it is possible to determine whether or not the injection molding machine to be used is appropriate. The display section displays the injection molding machine replacement time required to replace the injection molding machine when the injection molding machine is not appropriate in correspondence to the molded product to be molded. Thus, when the injection molding machine used is not appropriate, an operator can be informed of the time required to replace the injection molding machine with an appropriate one. Therefore, according to this aspect, the injection molding machine can be appropriately managed.

A third aspect of the present disclosure provides the injection molding machine management system according to the first or second aspect, in which the mold replacement time may include a time required to convey the mold and a time required to attach the mold.

According to this aspect, the mold replacement time includes the time required to convey the mold and the time required to attach the mold. Thus, an operator can accurately recognize the mold replacement time.

A fourth aspect of the present disclosure provides the injection molding machine management system according to any one of the first to third aspects, in which the material replacement time may include a time required to produce the material and a time required to transport the material.

According to this aspect, the material replacement time includes the time required to produce the material and the time required to transport the material. Thus, an operator can accurately recognize the material replacement time.

A fifth aspect of the present disclosure provides the injection molding machine management system according to any one of the first to fourth aspects, which may further include at least one of a temperature control device, a molded product take-out device, and a material charging device, in which the storage section may store identification information of the device included in the injection molding machine management system, the information input section may be configured to input information regarding the device included in the injection molding machine management system, the determination section may determine whether or not a device to be used is an appropriate device in correspondence to the molded product to be molded by using the identification information of the device included in the injection molding machine management system based on the molded product information that is input from the information input section, and the display section may display a device replacement time required to replace the device when the determination section determines that the device to be used is not the appropriate device in correspondence to the molded product to be molded.

According to this aspect, based on the information regarding at least one of the temperature control device, the molded product take-out device, and the material charging device input from the information input section, it is determined whether or not the device is appropriate in correspondence to the molded product to be molded. Thus, it is possible to determine whether or not the device to be used is appropriate. The display section displays the device replacement time required to replace the device when the device is not appropriate in correspondence to the molded product to be molded. Thus, when the device to be used is not appropriate, an operator can be informed of the time required to replace the device with an appropriate one. Therefore, according to this aspect, these devices can be appropriately managed.

A sixth aspect of the present disclosure provides the injection molding machine management system according to any one of the first to fifth aspects, in which the information input section may be any of a user interface, an image reading section, or a voice input section.

According to this aspect, the information input section is any of a user interface, an image reading section, or a voice input section. Thus, information can be easily input according to any of manual input by an operator using the user interface, input performed by reading a barcode or a QR code (registered trademark) by using the image reading section, or voice input by the operator using the voice input section.

A seventh aspect of the present disclosure provides the injection molding machine management system according to any one of the first to sixth aspects, in which the display section may display items in which the material information and the mold information do not match the mold identification information and the material identification information.

According to this aspect, the display section displays items in which the material information and the mold information do not match the mold identification information and the material identification information. Thus, when the mold or the material is not appropriate in correspondence to the molded product to be molded, an operator can recognize not only a determination result of an appropriate state or an inappropriate state but also whether a cause thereof is the mold or the material.

According to an eighth aspect of the present disclosure, there is provided an injection molding machine management method in an injection molding machine configured to inject a material into a mold to mold a molded product, including a storage step of storing, in a storage section, mold identification information of an appropriate mold determined in correspondence to a molded product to be molded and material identification information of an appropriate material determined in correspondence to the molded product to be molded; an information input step of inputting molded product information of the molded product to be molded, material information of a material to be used, and mold information of a mold to be used; a determination step of determining whether or not the mold and the material to be used are the appropriate mold and the appropriate material in correspondence to the molded product to be molded; and a display step of performing display based on a determination result in the determination step, in which in the determination step, it is determined whether or not the mold and the material to be used are the appropriate mold and the appropriate material in correspondence to the molded product to be molded by using the material information and the mold information that are input in the information input step and the mold identification information and the material identification information stored in the storage section based on the molded product information that is input in the information input step, and, in the display step, a mold replacement time required to replace the mold is displayed when it is determined in the determination step that the mold is not appropriate in correspondence to the molded product to be molded, and a material replacement time required to replace the material is displayed when it is determined in the determination step that the material is not appropriate in correspondence to the molded product to be molded.

According to this aspect, it is determined whether or not the mold and the material to be used are the appropriate mold and the appropriate material in correspondence to the molded product to be molded by using the mold information and the material information that are input in the information input step and the mold identification information and the material identification information stored in the storage section. Thus, it is possible to determine whether or not only the mold to be used but also the material to be used is appropriate. In the display step, the mold replacement time or the material replacement time required to replace the mold or the material is displayed when the mold or the material is not appropriate in correspondence to the molded product to be molded. Thus, when the mold or material to be used is not appropriate, an operator can be informed of the time required to replace the mold or the material with an appropriate one. Therefore, according to this aspect, the injection molding machine can be appropriately managed.

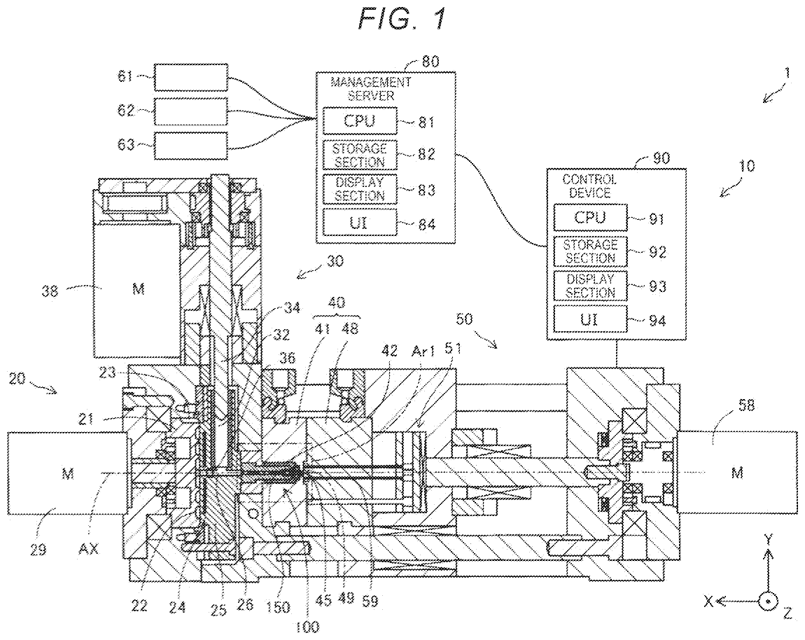

Hereinafter, embodiments according to the present disclosure will be described with reference to the accompanying drawings. First, with reference to FIG. 1, a schematic configuration of an injection molding machine management system 1 according to an example of the present disclosure will be described. The injection molding machine management system 1 of the present example includes an injection molding machine 10 including a control device 90, and a management server 80 capable of transmitting and receiving data to and from the control device 90. Although one management server 80 and one injection molding machine are illustrated in FIG. 1, the management server 80 manages a plurality of injection molding machines 10. However, the management server 80 may be configured to manage one injection molding machine 10. The injection molding machine management system 1 also includes a temperature control device 61, a molded product take-out device 62, and a material charging device 63. A drying device for the material or the like that can be used when the material is dried and used may be provided.

FIG. 1 schematically illustrates a cross section in which the injection molding machine 10 is cut along a vertical direction in a cross section including an axis AX of a flow path 150 formed in a hot runner 100, except for the control device 90. FIG. 1 illustrates an X axis, the Y axis, and the Z axis that are orthogonal to each other, and the +Z direction corresponds to a vertically upward direction. The axis AX is parallel to the X axis. The X axis, Y axis, and Z axis in FIG. 1 respectively correspond to the X axis, Y axis, and Z axis in other drawings. The injection molding machine 10 injects a material such as a thermoplastic resin into a mold to mold a molded product. The injection molding machine 10 includes a material generation section 20, an injection section 30, an injection molding mold 40, a mold opening/closing section 50, and the control device 90. The control device 90 may be integrally configured with the injection molding machine 10, or may be configured separately from the injection molding machine 10 and electrically coupled to the injection molding machine 10.

The material generation section 20 produces a fluid material by plasticizing or melting at least a part of a solid material supplied from a hopper (not illustrated) disposed vertically above, and supplies the fluid material to the injection section 30 side. Such a solid material is charged into the hopper in various granular forms such as pellet and powder. The material generation section 20 includes a flat screw 21, a barrel 25, and a drive motor 29.

The flat screw 21 has a substantially columnar appearance shape in which a length along the axis AX is smaller than a diameter. The flat screw 21 is disposed such that the axis AX of the flow path 150 formed in the hot runner 100 and the axis AX of the flat screw 21 coincide with each other. A groove 22 is formed on an end surface of the flat screw 21 on the side facing the barrel 25, and a material inflow port 23 is formed on an outer circumferential surface thereof. The groove 22 is continuous to the material inflow port 23. The material inflow port 23 receives a solid material supplied from the hopper.

A central section of the flat screw 21 is configured with a recess to which one end of the groove 22 is coupled, and faces a communication hole 26 of the barrel 25. The groove 22 of the flat screw 21 is configured with a so-called scroll groove, and is formed in a spiral shape to draw an arc from the central section where the axis AX is located toward the outer circumferential surface side of the flat screw 21. The groove 22 may be formed in a spiral shape.

The barrel 25 has a substantially disk-like appearance shape and is disposed to face the flat screw 21. A heater 24 as a heating section for heating a material is buried in the barrel 25. The barrel 25 is provided with the communication hole 26 penetrating along the axis AX. The communication hole 26 functions as a flow path for guiding the material to the hot runner 100. The barrel 25 is provided with an injection cylinder 32 that penetrates along an axis orthogonal to the axis AX. The injection cylinder 32 forms a part of the injection section 30 and communicates with the communication hole 26.

The drive motor 29 is coupled to an end surface of the flat screw 21 on the side opposite to the side facing the barrel 25. The drive motor 29 is driven in response to a command from the control device 90 to rotate the flat screw 21 with the axis AX as a rotation axis.

At least a part of the material supplied from the material inflow port 23 is plasticized or melted due to the rotation of the flat screw 21 while being heated by the heating member of the barrel 25 in the groove 22 of the flat screw 21 and to have high fluidity and is conveyed and guided to the communication hole 26. Compression and degassing of the material are also achieved due to the rotation of the flat screw 21. Here, the term “plasticization” refers to that a thermoplastic material is softened by being heated to a temperature equal to or higher than the glass transition point to exhibit fluidity. The term “melting” refers to not only that a thermoplastic material is heated to a temperature equal to or higher than the melting point to become a liquid but also that the thermoplastic material is plasticized.

The injection section 30 weighs the material supplied from the material generation section 20 and injects the material into a cavity 49 formed in a movable mold 48 of the injection molding mold 40. The injection section 30 includes an injection cylinder 32, an injection plunger 34, a check valve 36, an injection motor 38, and the hot runner 100.

The injection cylinder 32 is formed in a substantially cylindrical shape inside the barrel 25 and communicates with the communication hole 26. The injection plunger 34 is slidably disposed in the injection cylinder 32. When the injection plunger 34 slides in the +Y direction, the material in the communication hole 26 is drawn into the injection cylinder 32 and weighed. When the injection plunger 34 slides in the −Y direction, the material in the injection cylinder 32 is pumped toward the hot runner 100 and injected into the cavity 49. The check valve 36 is disposed in the communication hole 26 on the flat screw 21 side of a communication location between the injection cylinder 32 and the communication hole 26. The check valve 36 allows the material to flow from the flat screw 21 side to the hot runner 100 side, and suppresses backflow of the material from the hot runner 100 side to the flat screw 21 side. When the injection plunger 34 slides vertically downward, a spherical valve body of the check valve 36 moves toward the flat screw 21 side, and thus the communication hole 26 is closed. The injection motor 38 is driven in response to a command from the control device 90 to cause the injection plunger 34 to slide in the injection cylinder 32. A sliding speed and a sliding amount of the injection plunger 34 are set in advance according to the type of material, a size of the cavity 49, and the like. The hot runner 100 has a function of guiding the material to the cavity 49 in a state in which the material is heated.

The injection molding mold 40 has a fixed mold 41 and a movable mold 48. A hot runner attachment hole 42 penetrating along the axis AX is formed inside the fixed mold 41. The hot runner 100 is disposed in the hot runner attachment hole 42.

An inner diameter of the hot runner attachment hole 42 is gradually reduced in order from the material generation section 20 side. An end portion of the hot runner attachment hole 42 on the side opposite to the material generation section 20 side is formed in a substantially conical shape in which the inner diameter is gradually reduced. A tip side of the end portion functions as a gate opening 45 into which a shaping material flows. The gate opening 45 is configured with a substantially circular hole.

The movable mold 48 is disposed to face the fixed mold 41. The movable mold 48 comes into contact with the fixed mold 41 at the time of mold closing and mold clamping including when the shaping material is injected or cooled, and separates from the fixed mold 41 when the mold is opened including when a molded product is released from the mold. When the fixed mold 41 and the movable mold 48 come into contact with each other, a cavity 49 communicating with the gate opening 45 is formed between the fixed mold 41 and the movable mold 48. The cavity 49 is pre-designed in a shape of a molded product that is molded through injection molding. In the present example, the cavity 49 is formed in direct connection with the gate opening 45, but may be further connected via the runner.

The mold opening/closing section 50 illustrated in FIG. 1 opens/closes the fixed mold 41 and the movable mold 48. The mold opening/closing section 50 includes a mold opening/closing motor 58, a movable mold moving portion 51, and an extrusion pin 59. The mold opening/closing motor is driven in response to a command from the control device 90 to move the movable mold 48 along the axis AX. Consequently, the mold closing, mold clamping, and mold opening of the injection molding mold 40 are realized. The extrusion pin 59 is disposed at a position communicating with the cavity 49. The extrusion pin 59 extrudes a molded product when the mold is opened to release the molded product.

The control device 90 controls an operation of the entire injection molding machine 10 to execute injection molding. The control device 90 is configured with a computer having a CPU 91, a storage section 92, a display section 93, and a UI 94 that is a user interface. The CPU 91 functions as a control section by executing a control program stored in advance in the storage section 92. Here, the display section 93 and the UI 94 may be a touch panel, but the display section 93 may be a monitor and the UI 94 may be a keyboard, a mouse, or the like. As the storage section 92, for example, at least one of a ROM, a hard disk, an EEPROM, a RAM, and the like may be used.

The control device 90 can send and receive data to and from the management server 80 via an interface (not illustrated). The management server 80 is configured with a computer having a CPU 81, a storage section 82, a display section 83, and a UI 84 that is a user interface. Here, for example, the display section 83 may be a monitor, and the UI 84 may be a keyboard, mouse, or the like. As the storage section 82, for example, at least one of a ROM, a hard disk, an EEPROM, a RAM, and the like may be used.

As described above, the injection molding machine management system 1 of the present example includes the injection molding machine 10 capable of injecting a material into the injection molding mold 40 to mold a molded product. Various molded products can be formed by using a plurality of types of materials and a plurality of types of injection molding molds 40. Therefore, it is necessary to use an appropriate material and an appropriate injection molding mold 40 for a molded product to be molded.

Therefore, the storage section 82 of the management server 80 stores appropriate mold identification information of a mold determined in correspondence to a molded product to be molded and appropriate material identification information of a material determined in correspondence to the molded product to be molded. However, the mold identification information and the material identification information may be stored in the storage section 92. That is, the mold identification information and the material identification information need only be stored in at least one of the storage section 92 and the storage section 82, and there is no limitation as to where the information is stored. Molded product information of a molded product to be molded, material information of a material to be used, and mold information of the injection molding mold 40 to be used may be input from the UI 94 of the control device 90 as an information input section. The molded product information of the molded product to be molded, the material information of the material to be used, and the mold information of the injection molding mold 40 to be used may be input from the UI 84. That is, the information may be input from at least one of the UI 94 and the UI 84, and there is no limitation as to where the information input section is disposed. For the mold identification information, the material identification information, the molded product information, the mold information, and the material information, for example, an identification number (ID number) may be used.

Here, the CPU 81 of the management server 80 functions as a determination section determining whether or not the injection molding mold 40 and a material to be used are the appropriate injection molding mold 40 and an appropriate material in correspondence to a molded product to be molded. The CPU 81 determines whether or not the injection molding mold 40 and the material to be used are the appropriate injection molding mold 40 and an appropriate material in correspondence to a molded product to be molded by using the material information and mold information that are input from the UI 94 and the mold identification information and material identification information stored in the storage section 92 based on the molded product information input from the UI 94. However, the CPU 91 of the control device 90 may function as a determination section.

The display section 93 of the control device 90 performs display based on a determination result from the CPU 81. Specifically, among a plurality of injection molding machines 10 managed by the management server 80, whether or not there is the injection molding machine 10 in which the injection molding mold 40 and a material are not appropriate in correspondence to a molded product to be molded is displayed, and, when there is such an injection molding machine 10, identification information of the injection molding machine 10, mold identification information and material identification information stored in the storage section 92 corresponding to the appropriate injection molding mold 40 and material, and the mold information and the material information that are input from the UI 94 are displayed. When the CPU 81 determines that the injection molding mold 40 is not appropriate in correspondence to the molded product to be molded, a mold replacement time required to replace the injection molding molds 40 is displayed. When the CPU 81 determines that a material is not appropriate in correspondence to the molded product to be molded, a material replacement time required to replace the material is displayed.

As described above, the injection molding machine management system 1 of the present example determines whether or not the injection molding mold 40 and a material to be used are the appropriate injection molding mold 40 and an appropriate material in correspondence to a molded product to be molded, based on the mold information and the material information input from the information input section, and the mold identification information and the material identification information stored in the storage section 92. Therefore, the injection molding machine management system 1 of the present example can determine whether or not only the injection molding mold 40 to be used but also a material to be used is appropriate. In addition to a determination result from the CPU 81, when the injection molding mold 40 or a material is not appropriate in correspondence to a molded product to be molded, the display section 93 displays a mold replacement time or a material replacement time required to replace the injection molding mold 40 or materials. Therefore, when the injection molding mold 40 or the material to be used is not appropriate, an operator can be informed of a time required to replace the injection molding mold 40 or the material with an appropriate one. Therefore, the injection molding machine management system 1 of the present example can appropriately manage the injection molding machine 10. In the present example, even when the injection molding mold 40 or a material is not appropriate in correspondence to a molded product to be molded, a determination result from the CPU 81 is displayed as, for example, “OK” or “NG” in addition to the time required to replace with an appropriate one, but only the time replace with an appropriate one may be displayed without displaying the determination result. This is because, when the time required to replace with an appropriate one is displayed, it is clear that a determination result is “NG”, that is, the injection molding mold 40 or a material is not appropriate in correspondence to a molded product to be molded.

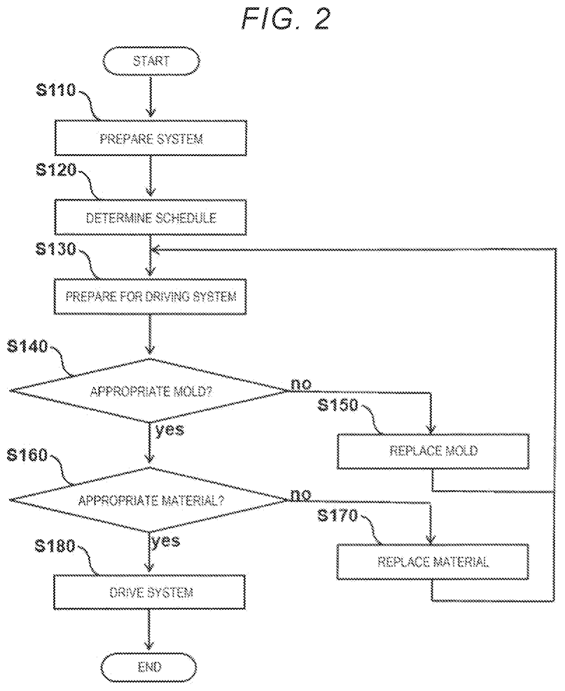

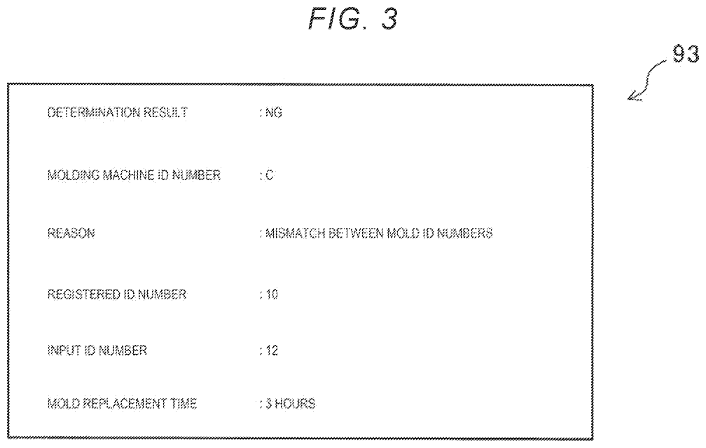

Hereinafter, an example of an injection molding machine management method performed by using the injection molding machine management system 1 of the present example illustrated in FIG. 1 will be described by using a flowchart of FIG. 2 with reference to FIGS. 3 to 5. As illustrated in the flowchart of FIG. 2, when the injection molding machine management method of the present example is started, first, in step S110, preparations are made to bring the injection molding machine management system 1 into a drivable state.

Specifically, in step S110, the injection molding machine 10 is set. For example, in addition to assembling the injection molding machine 10, mold identification information of the appropriate injection molding mold 40 determined in correspondence to a molded product to be molded, material identification information of an appropriate material determined in correspondence to the molded product to be molded, injection molding machine identification information of an appropriate injection molding machine determined in correspondence to the molded product to be molded, a standard time in each operation, an average molding time, a recommended drying time when the material to be used requires a drying step, and the like are also stored in the storage section 92 in this step.

Next, in step S120, a schedule for molding a molded product is determined by using the injection molding machine management system 1. Specifically, an operator inputs the name of the molded product, the molding date, and a planned number of molded products into the control device 90, and transmits the name of the molded product, the molding date, and the planned number of molded products from the control device 90 to the management server 80. The management server 80 acquires material identification information, mold identification information, a standard time in each operation, an average molding time, and a recommended drying time from the storage section 92 based on the name of the molded product. The management server 80 calculates a planned production time based on a product between the planned number of molded products and the average molding time. The management server 80 acquires, from the storage section 92, information regarding the availability of each injection molding machine 10 among the plurality of injection molding machines 10 and information regarding the availability of each injection molding mold 40 among the plurality of injection molding molds 40, and determines the injection molding machine 10 to be used and a production start time based on the planned production time. Here, the management server 80 associates the name of the molded product, the molding date, and the planned number of molded products with information regarding the injection molding machine management system 1 (specifically, identification information of the injection molding machine 10, identification information of the temperature control device 61, identification information of the molded product take-out device 62, identification information of the material charging device 63, and the like) and information regarding the molded product (specifically, material identification information, mold identification information, a standard time in each operation, an average molding time, a recommended drying time when the material is dried and used, and the like). The phrase “when the material is dried and used” corresponds to, for example, a case where a pellet-shaped material is used and the wet pellet is dried until the water content is appropriate for molding.

Next, in step S130, preparation for driving the injection molding machine management system 1 is performed. Based on a production schedule displayed on the display section 93 of the control device 90, for example, when the material is dried and used, the operator sets a drying time of a drying device for the material and charges the material into the drying device. The drying time is set to a recommended drying time, and the drying time is, for example, about 8 hours. The operator transports the injection molding mold 40 from a storage location of the injection molding mold 40 to an installation position of the injection molding machine 10. After the drying time has elapsed, the operator transports the material from the drying device to the injection molding machine 10. However, the transportation of the injection molding mold 40 and the transportation of the material may be performed at the same timing. The operator inputs the mold information and the material information into the injection molding machine 10 by using the UI 94. For example, bar codes are assigned to the injection molding mold 40 and a container for accommodating the material, and the mold information and the material information can be input by reading the barcodes. However, a method of reading a QR code (registered trademark) or a method of manually inputting the information by using UI 94 may be used.

When the preparation for driving the injection molding machine management system 1 is finished in step S130, it is determined in step S140 whether or not the injection molding mold 40 to be used is appropriate, and the determination result is displayed on the display section 93. Specifically, the control device 90 of the injection molding machine 10 transmits the mold information to the management server 80, and the management server 80 searches for the mold identification information stored in the storage section 82 based on the injection molding machine identification information stored in the storage section 82, and determines whether or not an ID number in the mold identification information matches an ID number in the mold information transmitted from the control device 90. In this step, when it is determined that the ID number in the mold identification information stored in the storage section 82 do not match the ID number in the mold information transmitted from the control device 90, and the injection molding mold 40 to be used is not the appropriate injection molding mold 40, the process proceeds to step S150. On the other hand, in this step, when it is determined that the ID number in the mold identification information stored in the storage section 82 matches the ID number in the mold information transmitted from the control device 90, and the injection molding mold 40 to be used is the appropriate injection molding mold 40, the process proceeds to step S160.

Here, FIG. 3 illustrates a display example on the display section 93 when the CPU 81 of the management server 80 determines that the ID number in the mold identification information stored in the storage section 82 do not match the ID number in the mold information transmitted from the control device 90, and the injection molding mold 40 to be used is not the appropriate injection molding mold 40. As illustrated in FIG. 3, the display section 93 displays the determination result, the ID number of the injection molding machine 10 in which the injection molding mold 40 is determined as not being appropriate, the reason of not being the appropriate injection molding mold 40, the ID number in the mold identification information registered in the storage section 82, the ID number in the mold information input by the control device 90, and a mold replacement time that is a guideline time required to replace a mold.

When the CPU 81 of the management server 80 determines that the ID number in the mold identification information registered in the storage section 82 does not match the ID number in the mold information input by the control device 90, the CPU 81 acquires the mold replacement time stored in the storage section 92. The mold replacement time is a standard time required for each operation. The mold replacement time is stored as a table for each weight of the injection molding mold 40 or each mold dimension, for example. In addition to the display, a replacement procedure for the injection molding mold 40 may be displayed.

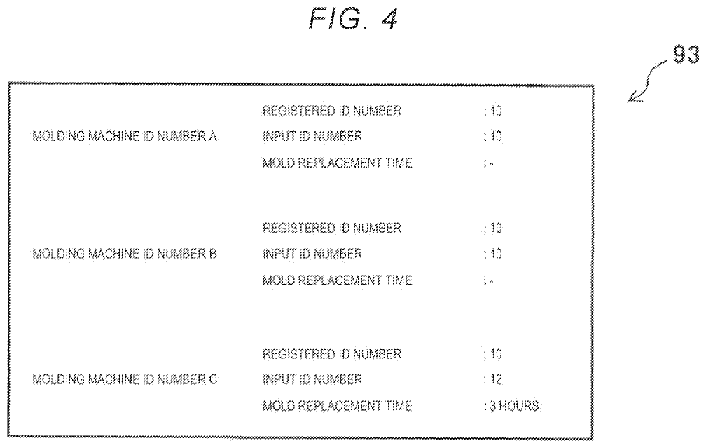

In step S140 of the present example, the management server 80 causes the CPU 81 to determine whether or not the injection molding mold 40 is appropriate, and transmits a determination result in the CPU 81 and a mold replacement time when the injection molding mold 40 is replaced to the control device 90 of the injection molding machine 10. As illustrated in FIG. 3, the control device displays the information on the display section 93. However, instead of the management server 80 determining whether or not the injection molding mold 40 is appropriate, the ID number as the mold identification information and the ID number as the mold information may be transmitted to the control device 90 of the injection molding machine 10, and may be displayed on the display section 93 together with the mold replacement time required for each injection molding machine 10 as illustrated in FIG. 4. In this case, regarding the display of the mold replacement time, the CPU 91 of the control device 90 determines whether or not the injection molding mold 40 is appropriate, and, as illustrated in FIG. 4, displays the mold replacement time on the display section 93 with respect to the injection molding machine 10 of which the injection molding mold 40 is determined as not being appropriate.

In step S150, the operator transfers an additional mold replacement time corresponding to the mold replacement time in FIGS. 3 and 4 to a production manager, and transports the appropriate injection molding mold 40 to the injection molding machine 10. After the inappropriate injection molding mold 40 has already been attached to the injection molding machine 10, an operation of detaching the inappropriate injection molding mold 40 from the injection molding machine 10 is performed. The operator returns the detached injection molding mold 40 to the mold storage location, transports an appropriate injection molding mold 40 to the injection molding machine 10, and attaches the appropriate injection molding mold 40 to the injection molding machine 10. Returning to step S130, the operator inputs new mold information to the control device 90 of the injection molding machine 10 by using the UI 94. The control device 90 transmits the mold information to the management server 80, and the management server 80 searches for the mold identification information based on the injection molding machine identification information, and determines in step S140 whether or not the mold identification information matches the mold information. When the management server 80 determines that the mold identification information and the mold information match each other, the process proceeds to step S160.

In step S160, it is determined whether or not the material to be used is appropriate, and the determination result is displayed on the display section 93. Specifically, the control device 90 of the injection molding machine 10 transmits material information to the management server 80, and the management server 80 searches for the material identification information stored in the storage section 82 based on the injection molding machine identification information stored in the storage section 82 and determines whether or not an ID number in the material identification information matches an ID number in the material information transmitted from the control device 90. In this step, when it is determined that the ID number in the material identification information stored in the storage section 82 does not match the ID number in the material information transmitted from the control device 90, and the material to be used is not an appropriate material, the process proceeds to step S170. On the other hand, in this step, when it is determined that the ID number in the material identification information stored in the storage section 82 matches the ID number in the material information transmitted from the control device 90, and the material to be used is an appropriate material, the process proceeds to step S180.

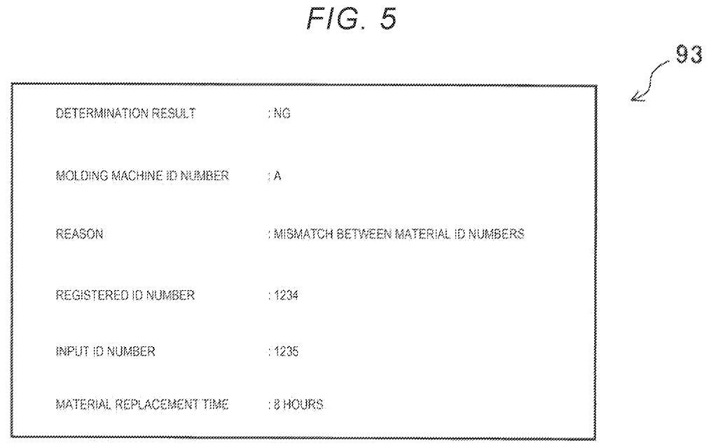

Here, FIG. 5 illustrates a display example on the display section 93 when the CPU 81 of the management server determines that the ID number in the material identification information stored in the storage section 82 does not match the ID number in the material information transmitted from the control device 90, and the material to be used is not appropriate. As illustrated in FIG. 5, the display section 93 displays the determination result, the ID number of the injection molding machine 10 in which the material is determined as not being appropriate, the reason why the material is determined as not being appropriate, the ID number in the material identification information registered in the storage section 82, the ID number in the material information input by the control device 90, and a material replacement time that is a guideline time required to replace the material.

When the CPU 81 of the management server 80 determines that the ID number in the material identification information registered in the storage section 82 does not match the ID number in the material information input by the control device 90, the CPU 81 acquires the material replacement time stored in the storage section 92. The material replacement time is a standard time required for each operation. As for the material replacement time, a recommended drying time is stored as a table in the storage section 82 for each material to be used. In addition to these indications, the material replacement procedure may be indicated. Here, in the present example, the determination of whether or not the injection molding mold 40 is appropriate, the determination of whether or not the material is appropriate, the display of the mold replacement time, and the display of the material replacement time are performed in different steps, but may be performed together in the same step.

In step S170, the operator transfers an additional material replacement time corresponding to the material replacement time in FIG. 5 to the production manager, and dries, for example, an appropriate material with the drying device and transports the material to the injection molding machine 10. After an inappropriate material has already been charged into the injection molding machine 10, an operation of removing the inappropriate material from the injection molding machine 10 is performed. The operator returns the removed material to the material storage location, transports the dried appropriate material to the injection molding machine 10, and charges the appropriate material into the injection molding machine 10. Returning to step S130, the operator inputs new material information to the control device 90 of the injection molding machine 10 by using the UI 94. The control device 90 transmits material information to the management server 80, and the management server 80 searches for the material identification information based on the injection molding machine identification information, and determines whether or not the material identification information matches the material information in step S160 via step S140. When the management server 80 determines that the material identification information matches the material information, the process proceeds to step S180.

In step S180, the injection molding machine 10 starts driving the injection molding machine management system 1 in order to start molding a molded product. Specifically, the management server 80 transmits a signal for permitting the start of production to the injection molding machine 10, and the injection molding machine 10 starts production. The injection molding machine management method of the present example is finished when molding of the molded product is finished.

As described above, the injection molding machine management method of the present example includes the storage step (step S110) of storing, in the storage section 82, mold identification information of the appropriate injection molding mold 40 determined in correspondence to a molded product to be molded and material identification information of an appropriate material determined in correspondence to the molded product to be molded. The injection molding machine management method includes the information input step (step S130) for inputting molded product information of the molded product to be molded, material information of the material to be used, and mold information of the injection molding mold 40 to be used. The injection molding machine management method includes the determination step (step S140 and step S160) of determining whether or not the injection molding mold 40 and the material to be used are an appropriate injection molding mold 40 and an appropriate material in correspondence to the molded product to be molded. The injection molding machine management method includes the display step (step S140 and step S160) of performing display based on a determination result in the determination step. Here, as described above, in the determination step, it is determined whether or not the injection molding mold 40 and the material to be used are the appropriate injection molding mold 40 and the appropriate material in correspondence to the molded product to be molded by using the material information and the mold information input in the information input step and the mold identification information and the material identification information stored in the storage section 82 based on the molded product information input in the information input step. As described above, in the display step, when it is determined in the determination step that the injection molding mold is not appropriate in correspondence to the molded product to be molded, a mold replacement time required to replace the injection molding mold 40 is displayed, and when it is determined in the determination step that the material is not appropriate in correspondence to the molded product to be molded, a material replacement time required to replace the material is displayed.

As described above, in the injection molding machine management method of the present example, it is determined whether or not the injection molding mold 40 and the material to be used are the appropriate injection molding mold 40 and material in correspondence to the molded product to be molded by using the mold information and the material information input in the information input step, and the mold identification information and the material identification information stored in the storage section 82. Thus, it can be determined whether or not only the injection molding mold 40 to be used but also the material to be used is appropriate. In the injection molding machine management method of the present example, in the display step, in addition to the determination result in the determination step, when the injection molding mold 40 or the material is not appropriate in correspondence to the molded product to be molded, the mold replacement time or the material replacement time required to replace the injection molding mold 40 or the material is displayed. Therefore, when the injection molding mold 40 or the material to be used is not appropriate, an operator can be informed of a time required to replace the injection molding mold 40 or the material with an appropriate one. Therefore, the injection molding machine 10 can be appropriately managed by executing the injection molding machine management method of the present example.

As described above, the injection molding machine management system 1 of the present example includes a plurality of injection molding machines 10. Specifically, as represented by molding machine ID numbers A, B, and C in FIG. 4, at least three injection molding machines 10 are provided. However, an injection molding machine 10 unsuitable for use may be further provided depending on a molded product to be molded. The storage section 82 stores injection molding machine identification information of the appropriate injection molding machine 10 determined in correspondence to each of molded products to be molded. The UI 94 can input injection molding machine information of the injection molding machine 10 to be used. The CPU 81 as a determination section determines whether or not the injection molding machine 10 to be used is the appropriate injection molding machine 10 in correspondence to a molded product to be molded by using the injection molding machine identification information stored in the storage section 82 based on the molded product information input from the UI 94. Here, when the CPU 81 determines that the injection molding machine 10 is not appropriate in correspondence to the molded product to be molded, the display section 93 can display an injection molding machine replacement time required to replace the injection molding machine 10.

Since the injection molding machine management system 1 of the present example has such a configuration, it is possible to determine whether or not the injection molding machine 10 to be used is appropriate. In addition to the determination result in the CPU 81, the display section 93 displays the injection molding machine replacement time required to replace the injection molding machine 10 when the injection molding machine 10 is not appropriate in correspondence to the molded product to be molded, and, thus, when the injection molding machine 10 to be used is not appropriate, the operator can be informed of the time required to replace the injection molding machine with an appropriate one. Therefore, the injection molding machine management system 1 of the present example can appropriately manage the injection molding machine 10. In the present example, even when the injection molding machine 10 is not appropriate in correspondence to a molded product to be molded, the determination result in the CPU 81 is displayed in addition to the time required to replace the injection molding machine 10 with an appropriate one, but only the time required to replace the injection molding machine 10 with an appropriate one may be displayed. This is because it is clear that the injection molding machine is not appropriate in correspondence to a molded product to be molded when the time required to replace the injection molding machine with an appropriate one is displayed.

Here, as described above, the mold replacement time includes the time required to convey the injection molding mold 40 and the time required to attach the injection molding mold 40. Thus, an operator can accurately recognize the mold replacement time.

As described above, the material replacement time includes the time required to produce a material and the time required to transport the material. Thus, an operator can accurately recognize the material replacement time. Here, the “time required to produce the material” includes not only the time required to mix and stir the material but also the time required to dry the material when a pellet-shaped material is used.

As in the injection molding machine management system 1 of the present example, at least one of the temperature control device 61, the molded product take-out device 62, and the material charging device 63 may be provided. In this case, preferably, the storage section 82 stores identification information of these devices included in the injection molding machine management system 1, the UI 94 can input information regarding these devices included in the injection molding machine management system 1, the CPU 81 determines whether or not a device to be used is an appropriate device in correspondence to a molded product to be molded by using identification information of the devices included in the injection molding machine management system 1 based on molded product information input from the UI 94, and the display section 93 displays a device replacement time required to replace the device when the CPU 81 determines that the device to be used is not an appropriate device in correspondence to the molded product to be molded. With such a configuration, it is possible to determine whether or not a device to be used is appropriate. In addition to a determination result in the CPU 81, the display section 93 displays a device replacement time required to replace the device when the CPU 81 determines that the device to be used is not appropriate in correspondence to the molded product to be molded, and thus an operator can be informed of the time required to replace the device with an appropriate one when the device is not appropriate. Therefore, with such a configuration, these devices can be appropriately managed. Even when a device is not appropriate in correspondence to a molded product to be molded, a determination result in the CPU 81 may be displayed in addition to the time required to replace the device with an appropriate device, but only the time required to replace the device with an appropriate device may be displayed. This is because it is clear that the device is not appropriate in correspondence to the molded product to be molded when the time required to replace the device with an appropriate one is displayed.

In the injection molding machine management system 1 of the present example, the information input section is a user interface, but may be either an image reading section or a voice input section. This is because information can be easily input according to any of manual input by an operator using a user interface, input performed by reading a barcode or a QR code (registered trademark) by using an image reading section, or voice input by an operator using a voice input section.

As illustrated in FIGS. 3 to 5, in the injection molding machine management system 1 of the present example, the display section 93 displays items in which the material information and the mold information do not match the mold identification information and the material identification information as a determination result in the CPU 81. Thus, when the injection molding mold 40 or a material is not appropriate in correspondence to a molded product to be molded, the injection molding machine management system 1 of the present example enables an operator to recognize not only a determination result of an appropriate state or an inappropriate state but also whether a cause thereof is the injection molding mold 40 or the material.

The present disclosure is not limited to the above-described example, and can be realized with various configurations without departing from the spirit of the present disclosure. The technical features in the Example corresponding to the technical features in each aspect described in the column of Summary may be replaced or combined as appropriate in order to solve some or all of the above-described problems or to achieve some or all of the above-described effects. Unless the technical feature is described as essential in the present specification, the technical feature may be deleted as appropriate.

What is claimed is:

1. An injection molding machine management system comprising:
an injection molding machine that is configured to inject a material into a mold to mold a molded product;
a storage section that stores mold identification information of an appropriate mold determined in correspondence to a molded product to be molded and material identification information of an appropriate material determined in correspondence to the molded product to be molded;
an information input section that is configured to input molded product information of the molded product to be molded, material information of a material to be used, and mold information of a mold to be used;
a determination section that determines whether or not the mold and the material to be used are the appropriate mold and the appropriate material in correspondence to the molded product to be molded; and
a display section that performs display based on a determination result in the determination section, wherein
the determination section determines whether or not the mold and the material to be used are the appropriate mold and the appropriate material in correspondence to the molded product to be molded by using the material information and the mold information that are input from the information input section and the mold identification information and the material identification information stored in the storage section based on the molded product information that is input from the information input section, and
the display section displays a mold replacement time required to replace the mold when the determination section determines that the mold is not appropriate in correspondence to the molded product to be molded, and displays a material replacement time required to replace the material when the determination section determines that the material is not appropriate in correspondence to the molded product to be molded.

2. The injection molding machine management system according to claim 1, further comprising:
a plurality of the injection molding machines, wherein
the storage section stores injection molding machine identification information of an appropriate injection molding machine determined in correspondence to each of molded products to be molded,
the information input section is configured to input injection molding machine information of an injection molding machine to be used,
the determination section determines whether or not the injection molding machine to be used is the appropriate injection molding machine in correspondence to the molded product to be molded by using the injection molding machine identification information stored in the storage section based on the molded product information that is input from the information input section, and
the display section displays an injection molding machine replacement time required to replace the injection molding machine when the determination section determines that the injection molding machine is not appropriate in correspondence to the molded product to be molded.

3. The injection molding machine management system according to claim 1, wherein
the mold replacement time includes a time required to convey the mold and a time required to attach the mold.

4. The injection molding machine management system according to claim 1, wherein
the material replacement time includes a time required to produce the material and a time required to transport the material.

5. The injection molding machine management system according to claim 1, further comprising:
at least one of a temperature control device, a molded product take-out device, and a material charging device, wherein
the storage section stores identification information of the device included in the injection molding machine management system,
the information input section is configured to input information regarding the device included in the injection molding machine management system,
the determination section determines whether or not a device to be used is an appropriate device in correspondence to the molded product to be molded by using the identification information of the device included in the injection molding machine management system based on the molded product information that is input from the information input section, and
the display section displays a device replacement time required to replace the device when the determination section determines that the device to be used is not the appropriate device in correspondence to the molded product to be molded.

6. The injection molding machine management system according to claim 1, wherein
the information input section is any of a user interface, an image reading section, or a voice input section.

7. The injection molding machine management system according to claim 1, wherein
the display section displays items in which the material information and the mold information do not match the mold identification information and the material identification information.

8. An injection molding machine management method in an injection molding machine configured to inject a material into a mold to mold a molded product, the injection molding machine management method comprising:
a storage step of storing, in a storage section, mold identification information of an appropriate mold determined in correspondence to a molded product to be molded and material identification information of an appropriate material determined in correspondence to the molded product to be molded;
an information input step of inputting molded product information of the molded product to be molded, material information of a material to be used, and mold information of a mold to be used;
a determination step of determining whether or not the mold and the material to be used are the appropriate mold and the appropriate material in correspondence to the molded product to be molded; and
a display step of performing display based on a determination result in the determination step, wherein
in the determination step, it is determined whether or not the mold and the material to be used are the appropriate mold and the appropriate material in correspondence to the molded product to be molded by using the material information and the mold information that are input in the information input step and the mold identification information and the material identification information stored in the storage section based on the molded product information that is input in the information input step, and
in the display step, a mold replacement time required to replace the mold is displayed when it is determined in the determination step that the mold is not appropriate in correspondence to the molded product to be molded, and a material replacement time required to replace the material is displayed when it is determined in the determination step that the material is not appropriate in correspondence to the molded product to be molded.
